(19) United States
(12) Patent Application Publication
(10) Pub. No.: US 2009/0047550 A1
(43) Pub. Date: Feb. 19, 2009

(54) METHOD FOR MANUFACTURING FUEL CELL, FUEL CELL, AND ELECTRONIC APPARATUS

(75) Inventors: Masaya Kakuta, Kanagawa (JP); Hideki Sakai, Kanagawa (JP); Takaai Nakagawa, Kanagawa (JP); Yuichi Tokita, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/190,367

(22) Filed: Aug. 12, 2008

(30) Foreign Application Priority Data
Aug. 17, 2007 (JP) 2007-212703

(51) Int. Cl. H01M 8/00; B05D 3/06

(52) U.S. Cl. 429/12; 427/115; 427/487; 156/60

(57) ABSTRACT

A method for manufacturing a fuel cell having a structure in which a positive electrode and a negative electrode are opposed with a proton conductor therebetween and an enzyme is immobilized on the positive electrode and/or the negative electrode includes the step of immobilizing the enzyme on the positive electrode and/or the negative electrode with a photo-curable resin and/or a thermosetting resin. A photo-curable resin and/or a thermosetting resin may be further laminated on the photo-curable resin and/or the thermosetting resin which have immobilized the enzyme.

### CROSS REFERENCES TO RELATED APPLICATIONS

The present application claims priority to Japanese Patent Application JP 2007-212703 filed in the Japanese Patent Office on Aug. 17, 2007, the entire contents of which is incorporated herein by reference.

### BACKGROUND

The present disclosure relates to a method for manufacturing a fuel cell, a fuel cell, and an electronic apparatus. In particular, the present disclosure is suitable for application to a biofuel cell by using an enzyme and various electronic apparatuses including this biofuel as a power source.

The fuel cell has a structure in which a positive electrode (oxidant electrode) and a negative electrode (fuel electrode) are opposed with an electrolyte (proton conductor) therebetween. In the fuel cell according to the related art, a fuel (hydrogen) supplied to the negative electrode is oxidized and is separated into electrons and protons (H⁺). The electron is passed to the negative electrode, and H⁺ moves through the electrolyte to the positive electrode. At the positive electrode, this H⁺ reacts with oxygen supplied from the outside and the electron transferred from the negative electrode through an external circuit so as to generate H₂O.

As described above, the fuel cell is a highly efficient power generation apparatus which directly converts chemical energy held by a fuel to electrical energy and can take out chemical energy held by fossil energy, e.g., natural gases, petroleum, and coal, as electrical energy at a high conversion efficiency regardless of site of use and time of use. Consequently, development and research on the fuel cell for application to large scale power generation and the like have been previously actively conducted. For example, there is a track record of mounting a fuel cell on a space shuttle so as to verify that the electric power and water for a crew can be supplied at the same time and the fuel cell is a clean power generation apparatus.

Furthermore, in recent years, fuel cells, e.g., solid polymer type fuel cells, exhibiting relatively low operation temperature ranges of room temperature to about 90° C. have been developed and noted. Consequently, not only the applications to large scale power generation, but also applications to small systems, e.g., power sources for driving automobiles and portable power sources for personal computers, mobile devices, and the like, have been searched.

As described above, regarding fuel cells, wide applications from large scale power generation to small scale power generation are expected, and fuel cells have been significantly noted as highly efficient power generation apparatuses. However, in the fuel cell, usually, natural gases, petroleum, coal, and the like are used as fuels by being converted to a hydrogen gas with a reformer. Therefore, there are various problems in that, for example, limited resources are consumed, heating to high temperatures is required, and expensive noble metal catalysts, e.g., platinum (Pt) are needed. In the case where a hydrogen gas or methanol is directly used as a fuel as well, cautions are needed in handling thereof.

Then, it has been noted that living body metabolism performed in living things is highly efficient energy conversion mechanism, and a proposal to apply this to a fuel cell have been made. Here, the living body metabolism includes breathing, photosynthesis, and the like performed in microbial somatic cell. The living body metabolism has advantages, in combination, that the power generation efficiency is very high and a reaction proceeds under a mild condition on the order of room temperature.

For example, the breathing is a mechanism in which nutrients, e.g., saccharides, fat, and proteins, are taken into microbes or cells, the chemical energy thereof is converted to oxidation-reduction energy, that is, electrical energy, by reducing nicotinamide adenine dinucleotide (NAD⁺) to nicotinamide adenine dinucleotide reduced (NADH) in a process for generating carbon dioxide (CO₂) through a glycolitic pathway and a tricarboxylic acid (TCA) cycle including many enzyme reaction steps and, furthermore, in a electron transport system, the electrical energy of NADH is directly converted to the electrical energy of a proton gradient and, in addition, oxygen is reduced so as to generate water. The electrical energy obtained here generates adenosine triphosphate (ATP) from adenosine diphosphate (ADP) through an ATP synthesis enzyme, and the resulting ATP is used for a reaction required for growing microbes and cells. The above-described energy conversion is conducted in cytosol and mitochondria.

The photosynthesis is a mechanism in which water is oxidized so as to generate oxygen in a process for taking in and converting light energy to electrical energy by reducing nicotinamide adenine dinucleotide phosphate (NADP⁺) to nicotinamide adenine dinucleotide phosphate reduced (NADPH) through the electron transport system. The resulting electrical energy takes in CO₂, is used for a carbon immobilization reaction, and is used for synthesis of carbohydrates.

As for a technology to use the above-described living body metabolism for a fuel cell, a microbial cell has been reported, in which electrical energy generated in microbes is taken out of the microbes through an electron mediator and the electron is passed to an electrode so as to obtain a current (refer to Japanese Unexamined Patent Application Publication No. 2000-133297, for example).

However, regarding microbes and cells, many unnecessary reactions are present besides the desired reaction, that is, conversion of chemical energy to electrical energy. Therefore, in the above-described method, the chemical energy is consumed in undesired reactions and satisfactory energy conversion efficiency is not exhibited.

Then, a fuel cell (biofuel cell) has been proposed, in which only a desired reaction is conducted by using an enzyme (refer to Japanese Unexamined Patent Application Publication No. 2003-282124, Japanese Unexamined Patent Application Publication No. 2004-71559, Japanese Unexamined Patent Application Publication No. 2005-13210, Japanese Unexamined Patent Application Publication No. 2005-310613, Japanese Unexamined Patent Application Publication No. 2006-24555, Japanese Unexamined Patent Application Publication No. 2006-49215, Japanese Unexamined Patent Application Publication No. 2006-93090, Japanese Unexamined Patent Application Publication No. 2006-127957, Japanese Unexamined Patent Application Publication No. 2006-156354, Japanese Unexamined Patent Application Publication No. 2007-12281, for example). This biofuel cell decomposes a fuel by using an enzyme to separate the fuel into protons and electrons. Biofuel cells by using alcohols, e.g., methanol and ethanol, monosaccharides, e.g., glucose, or polysaccharides, e.g., starch, as fuels have been developed.

It is known that immobilization of the enzyme relative to the electrode is very important in the biofuel cell and exerts a significant influence on an output characteristic, a life, an efficiency, and the like. Therefore, it is very important to conduct immobilization with minimum damage to the enzyme in the production process of an enzyme immobilization electrode. As for the method for immobilizing the enzyme, a covalent binding method, a physical entrapment method, a gel entrapment method, and the like have been known previously.

In the above-described covalent binding method, in order to conduct a covalent binding reaction of an enzyme and, for example, a polymer, a low molecular compound called a linker is used in many cases. However, this method is in need of optimizing the reaction condition and, therefore, is relatively complicated. There is a disadvantage that the number of binding is limited to the number of functional groups in the polymer. The physical entrapment method and the gel entrapment method are on the basis of a physical interaction between an enzyme and, for example, a polymer. Although many enzymes can be immobilized, it is a disadvantage that the interaction force is small. Consequently, it is known that there is a high possibility of elimination of enzyme from an enzyme immobilization electrode during use in contrast to the covalent binding method. Furthermore, there is a disadvantage that if ionic balance is lost, the elimination rate of enzyme increases.

Consequently, the electrode of a biofuel cell is in need of immobilizing many enzymes while damage is reduced, and development of new enzyme immobilization technology in place of the above-described covalent binding method, physical entrapment method, and gel entrapment method has been desired.

There is a method in which many enzymes, electron mediators, and the like are immobilized on an electrode. This is one of methods for realizing an increase in output and an improvement of performance of a biofuel cell. However, enzymes, electron mediators, and the like essentially have a water-soluble property. Therefore, there is a problem in that elution (leakage) into an electrolyte solution and the like occurs during use and significant deterioration with time results. Furthermore, it is also a significant problem that the elution of enzymes, electron mediators, and the like, which are immobilized on the electrode, reduce the life of the biofuel cell.

Accordingly, it is desirable to provide a method for manufacturing a fuel cell, wherein at least one type of enzyme can be immobilized easily on an optimum position of a positive electrode and/or a negative electrode with reduced damage and a high performance fuel cell having excellent output characteristic, life, efficiency, and the like can be produced, such a fuel cell, and an electronic apparatus including the fuel cell.

Moreover, it is desirable to provide a method for manufacturing a fuel cell, wherein elution of enzyme and the like, which are immobilized on a positive electrode and/or a negative electrode, can be reduced and a high performance fuel cell having excellent output characteristic, life, efficiency, and the like can be produced, such a fuel cell, and an electronic apparatus including the fuel cell.

### SUMMARY

In an embodiment, the use of a photo-curable resin is very effective for immobilizing a substance containing an enzyme on a positive electrode or a negative electrode of a biofuel cell and the effectiveness thereof has been ascertained through experiments. A thermosetting resin may be used in place of the photo-curable resin or the two may be used in combination. Furthermore, it was found that after the substance containing an enzyme was immobilized with the photo-curable resin and/or the thermosetting resin, the photo-curable resin and/or the thermosetting resin was further laminated thereon so as to serve as a sealing layer, elution (leakage) of the component of immobilization film was reduced, and a catalyst current value was able to be increased dramatically. An increase in output and an improvement of performance of a biofuel cell can be conducted by combination of immobilization of the substance containing an enzyme with the photo-curable resin and/or the thermosetting resin and sealing with the photo-curable resin and/or the thermosetting resin. The use of the photo-curable resin or the thermosetting resin in the case where the substance containing an enzyme is immobilized on the positive electrode or the negative electrode of the biofuel cell has not been proposed until now to the knowledge of the present inventers.

Furthermore, it was determined that after the substance containing an enzyme was immobilized by a polyion complex method based on the prior art, the photo-curable resin and/or the thermosetting resin was further laminated thereon and, thereby, the same effect as that in the case where the substance containing an enzyme was immobilized with the photo-curable resin and/or the thermosetting resin was able to be obtained.

The present application has been made on the basis of the above-described findings obtained by the present inventors originally.

A method for manufacturing a fuel cell having a structure in which a positive electrode and a negative electrode are opposed with a proton conductor therebetween and an enzyme is immobilized on the above-described positive electrode and/or the above-described negative electrode, according to an embodiment, includes the step of immobilizing the above-described enzyme on the above-described positive electrode and/or the above-described negative electrode with a photo-curable resin and/or a thermosetting resin.

A fuel cell according to an embodiment having a structure in which a positive electrode and a negative electrode are opposed with a proton conductor therebetween and an enzyme is immobilized on the above-described positive electrode and/or the above-described negative electrode, wherein the above-described enzyme is immobilized on the above-described positive electrode and/or the above-described negative electrode with a photo-curable resin and/or a thermosetting resin.

An electronic apparatus according to an embodiment includes at least one fuel cell, wherein at least one of the fuel cells comprising a structure in which a positive electrode and a negative electrode are opposed with a proton conductor therebetween and an enzyme is immobilized on the above-described positive electrode and/or the above-described negative electrode, wherein the above-described enzyme is immobilized on the above-described positive electrode and/or the above-described negative electrode with a photo-curable resin and/or a thermosetting resin.

A method for manufacturing a fuel cell having a structure in which a positive electrode and a negative electrode are opposed with a proton conductor therebetween and an enzyme is immobilized on the above-described positive electrode and/or the above-described negative electrode, according to an embodiment, includes the steps of immobilizing the above-described enzyme on the above-described positive electrode and/or the above-described negative electrode with a immobilizing material and laminating a photo-curable resin and/or a thermosetting resin on the above-described immobilizing material.

A fuel cell according to an embodiment has a structure in which a positive electrode and a negative electrode are opposed with a proton conductor therebetween and an enzyme is immobilized on the above-described positive electrode and/or the above-described negative electrode, wherein the above-described enzyme is immobilized on the above-described positive electrode and/or the above-described negative electrode with an immobilizing material, and a photo-curable resin and/or a thermosetting resin is laminated on the above-described immobilizing material.

An electronic apparatus according to an embodiment includes at least one fuel cell, at least one of the fuel cells having a structure in which a positive electrode and a negative electrode are opposed with a proton conductor therebetween and an enzyme is immobilized on the above-described positive electrode and/or the above-described negative electrode, wherein the above-described enzyme is immobilized on the above-described positive electrode and/or the above-described negative electrode with an immobilizing material, and a photo-curable resin and/or a thermosetting resin is laminated on the above-described immobilizing material.

In the above description, preferably, an electron mediator besides the enzyme is immobilized on the positive electrode and/or the negative electrode.

In the case where the enzyme is immobilized on the positive electrode and/or the negative electrode with the photo-curable resin and/or the thermosetting resin, typically, a solution containing the enzyme and the photo-curable resin and/or the thermosetting resin is applied to the positive electrode and/or the negative electrode, drying is conducted, if necessary, and thereafter, light irradiation and/or heating is conducted so as to cure the photo-curable resin and/or the thermosetting resin. As for the photo-curable resin and/or the thermosetting resin, preferably, a water-soluble photo-curable resin and/or a water-soluble thermosetting resin is used. One enzyme immobilization layer or at least two enzyme immobilization layers containing mutually different enzymes are formed on the positive electrode and/or the negative electrode, as necessary. In particular, in the case where the photo-curable resin is used, light is applied by using a photomask having a predetermined mask pattern, if necessary, and thereafter, development is conducted so as to remove an unexposed photo-curable resin. In this manner, the enzyme immobilization layer in which the enzyme has been immobilized with the photo-curable resin can be formed into various shapes. In the case where the water-soluble photo-curable resin is used as the photo-curable resin, since an unexposed water-soluble photo-curable resin can be removed by conducting development with water, a load on the environment can be reduced.

After the enzyme is immobilized on the positive electrode and/or the negative electrode with the photo-curable resin and/or the thermosetting resin, if necessary, an appropriate amount of solution containing a photo-curable resin and/or a thermosetting resin may be laminated so as to laminate the photo-curable resin and/or the thermosetting resin. The thus laminated photo-curable resin and/or thermosetting resin serves as a sealing layer and, thereby, elution of components (enzyme, electron mediator, and the like) immobilized on the positive electrode and/or the negative electrode can be reduced and the catalyst current value can be increased significantly.

As for the water-soluble photo-curable resin, various resins can be used and selected as necessary. In general, if the water solubility is too high, the adhesion of the enzyme immobilization layer to the positive electrode and/or the negative electrode tends to decrease in the production of the positive electrode and/or the negative electrode. Therefore, it is preferable that the resin having an appropriate water solubility is used. As for the water-soluble photo-curable resin, specifically, for example, resins having an azide based photosensitive group and resins having at least two ethylenic unsaturated bonds in the molecule can be used.

As for the water-soluble photo-curable resin having at least two ethylenic unsaturated bonds in the molecule, in general, resins which have number average molecular weights within the range of 300 to 30,000, preferably 500 to 20,000, which contains ionic or nonionic hydrophilic groups, e.g., hydroxyl groups, amino groups, carboxy groups, phosphate groups, and ether bonds, adequate for homogeneously dispersing in an aqueous medium, and which are cured and converted to water-insoluble resins by being irradiated with light having wavelengths within the range of about 250 to about 600 nm are used favorably. As for such a water-soluble photo-curable resin, for example, resins which are previously known as immobilization supports for entrapping immobilization can be used (refer to Japanese Examined Patent Application Publication No. 55-40, Japanese Examined Patent Application Publication No. 55-20676, and Japanese Examined Patent Application Publication No. 62-19837, for example). Typical examples of the water-soluble photo-curable resins are as described below.

(1) Compounds having photopolymerizable ethylenic unsaturated bonds at both terminals of polyalkylene glycol. Specific examples thereof include the following compounds, although not limited to them.
Polyethylene glycol di(meth)acrylates produced by esterifying both terminal hydroxyl groups of 1 mol of polyethylene glycol having a molecular weight of 400 to 6,000 with 2 mol of (meth)acrylic acid
Polypropylene glycol di(meth)acrylates produced by esterifying both terminal hydroxyl groups of 1 mol of polypropylene glycol having a molecular weight of 200 to 4,000 with 2 mol of (meth)acrylic acid
Urethanated unsaturated polyethylene glycols produced by urethanating both terminal hydroxyl groups of 1 mol of polyethylene glycol having a molecular weight of 400 to 6,000 with 2 mol of diisocyanate compounds, e.g., torylene diisocyanate, xylylene diisocyanate, and isophorone diisocyanate, and adding 2 mol of unsaturated monohydroxyethyl compound, e.g., 2-hydroxyethyl(meth)acrylate
Urethanated unsaturated polypropylene glycols produced by urethanating both terminal hydroxyl groups of 1 mol of polypropylene glycol having a molecular weight of 200 to 4,000 with 2 mol of diisocyanate compounds, e.g., torylene diisocyanate, xylylene diisocyanate, and isophorone diisocyanate, and adding 2 mol of unsaturated monohydroxyethyl compound, e.g., 2-hydroxyethyl(meth)acrylate

(2) High acid value unsaturated polyester resin

An unsaturated polyester resin refers to a resin solution in which a resin produced from a dibasic acid, e.g., maleic anhydride and fumaric acid, having an unsaturated bond, phthalic anhydride having a saturated bond and exhibiting no polymerizability for obtaining appropriate cross-linkage, and a dihydric alcohol, e.g., ethylene glycol and propylene glycol, is dissolved into a polymerizable monomer (styrene monomer or the like). A curing agent, a reaction initiator, and an organic peroxide, e.g., peroxide, are used as a catalyst.

The solution containing the enzyme and the water-soluble photo-curable resin is allowed to contain a photopolymerization initiator, if necessary. This photopolymerization initiator serves as a polymerization initiation species and effects a cross-linking reaction between resins having polymerizable unsaturated groups. Examples thereof include α-carbonyls, e.g., benzoin, acyloin ethers, e.g., benzoin ethyl ether, polycyclic aromatic compounds, e.g., naphthol, α-substituted acyloins, e.g., methylbenzoin, and azoamide compounds, e.g., 2-cyano-2-butylazoformamide. In this case, the use ratio of the water-soluble photo-curable resin to the photopolymerization initiator is not strictly limited, and can be changed over a wide range depending on the type and the like of individual components. In general, it is appropriate that the photopolymerization initiator is used at a ratio of 0.1 to 5 parts by mass, and preferably 0.3 to 3 parts by mass relative to 100 parts by mass of water-soluble photo-curable resin.

As for the water-soluble thermosetting resin, for example, water-soluble paints can be used. Water-based paints can be roughly classified into an aqueous solution type which can be diluted with water, a dispersion type which has vehicle dispersed in water, and an emulsion type. As for the aqueous solution type paint, a self cross-linking type primarily including thermosetting acrylic emulsion and a water-soluble melamine resin cross-linking type are superior, and are used frequently. Regarding the dispersion type paint, raw materials are a synthetic resin emulsion and latex, and dispersion media are water and a very small amount of organic solvent. Examples of emulsion type paints include vinyl acetate emulsion, acrylic acid ester emulsion, styrene butadiene latex, and SBR latex. In each case, the organic solvent content is very low. Therefore, an air pollution control effect is significant, and a load on the environment can be reduced.

In the embodiments, as for the immobilizing material to immobilize the enzyme, basically, any material may be used. Previously known materials, e.g., polyion complexes, can be used. In addition, the above-described photo-curable resin, thermosetting resin, and the like can be used. As for the polyion complex, previously known complexes can be used, and are selected as necessary. For example, polyion complexes formed by using poly-L-lysine (PLL) and other polycations or salts thereof and polyacrylic acid (for example, sodium polyacrylate (PAAcNa)) and other polyanions or salts thereof can be used.

In the embodiments, as for the photo-curable resin and/or the thermosetting resin laminated on the polyion complex, the same photo-curable resins and thermosetting resins as those described in the case where the enzyme is immobilized with the photo-curable resin and/or the thermosetting resin can be used.

In the embodiments, as for the fuel, various substances can be used and are selected as necessary. Typical examples thereof include methanol, ethanol, monosaccharides, polysaccharides, and fats. In the case where monosaccharides, polysaccharides, and the like are used as the fuel, typically, they are used in the form of a fuel solution in which they are dissolved in a previously known buffer solution, e.g., a phosphate buffer solution or a Tris buffer solution.

For example, in the case where monosaccharides, e.g., glucose, are used as the fuel, it is preferable that an oxidizing enzyme which facilitates oxidation of the monosaccharides so as to decompose and a coenzyme-oxidizing enzyme which returns a coenzyme reduced by the oxidizing enzyme to an oxidized form are immobilized as enzymes on a enzyme immobilization electrode serving as the negative electrode. Electrons are generated when the coenzyme is returned to the oxidized form by the action of the coenzyme-oxidizing enzyme, and the electrons are passed to the electrode from the coenzyme-oxidizing enzyme through the electron mediator. As for the oxidizing enzyme, for example, NAD⁺-dependent glucose dehydrogenase (GDH) is used. As for the coenzyme, for example, nicotinamide adenine dinucleotide (NAD⁺) or nicotinamide adenine dinucleotide phosphate (NADP⁺) is used. As for the coenzyme-oxidizing enzyme, for example, diaphorase (DI) is used.

As for the electron mediator, basically, any compound may be used. Preferably, compounds having a quinone skeleton, most of all, compounds having a naphthoquinone skeleton are used. As for the compounds having a naphthoquinone skeleton, various naphthoquinone derivatives can be used. Specifically, for example, 2-amino-1,4-naphthoquinone (ANQ), 2-amino-3-methyl-1,4-naphthoquinone (AMNQ), 2-methyl-1,4-naphthoquinone (VK3), 2-amino-3-carboxy-1,4-naphthoquinone (ACNQ), and vitamin K1 are used. As for the compounds having a quinone skeleton, for example, anthraquinone and derivatives thereof can also be used besides the compounds having a naphthoquinone skeleton. The electron mediator may contain at least one type of other compounds serving as the electron mediator, if necessary, besides the compounds having a quinone skeleton.

In the case where polysaccharides (referring to polysaccharides in a broad sense, referring to all carbohydrates which generate at least two molecules of monosaccharide through hydrolysis, and including oligosaccharides, e.g., disaccharides, trisaccharides, and tetrasaccharides) are used, preferably, a decomposition enzyme which facilitates decomposition, e.g., hydrolysis, of polysaccharides and generates monosaccharides, e.g., glucose, is also immobilized in addition to the above-described oxidizing enzyme, coenzyme-oxidizing enzyme, coenzyme, and electron mediator. Specific examples of polysaccharides include starch, amylose, amylopectin, glycogen, cellulose, maltose, sucrose, and lactose. They are composed of at least two monosaccharides bonded, all polysaccharides include glucose as a monosaccharide of bonding unit. Amylose and amylopectin are components contained in starch. Starch is a mixture of amylase and amylopectin. In the case where glucoamylase is used as a decomposition enzyme for polysaccharides and glucose dehydrogenase is used as oxidizing enzyme for decomposing monosaccharides, power generation can be conducted by using fuels containing polysaccharides which can be decomposed to glucose by glucoamylase, for example, any one of starch, amylose, amylopectin, glycogen, and maltose. Glucoamylase is a decomposition enzyme which hydrolyzes α-glucan, e.g., starch, to generate glucose and glucose dehydrogenase is an oxidizing enzyme which oxidizes β-D-glucose to D-glucono-δ-lactone.

The fuel cell, in which cellulase is used as the decomposition enzyme and glucose dehydrogenase is used as the oxidizing enzyme, can use cellulose, which can be decomposed to glucose by cellulase, as the fuel. For more details, cellulase is at least one type of cellulase (EC 3.2.1.4), exo-cellobiohydrolase (EC 3.2.1.91), β-glucosidase (EC 3.2.1.21), and the like. A mixture of glucoamylase and cellulase may be used as a decomposition enzyme. In this case, since most of polysaccharides produced in the natural world can be decomposed, substances containing them to a large extent, for example, garbage, can be used as fuels.

The fuel cell, in which α-glucosidase is used as the decomposition enzyme and glucose dehydrogenase is used as the oxidizing enzyme, can use maltose, which is decomposed to glucose by α-glucosidase, as the fuel.

The fuel cell, in which sucrase is used as the decomposition enzyme and glucose dehydrogenase is used as the oxidizing enzyme, can use sucrose, which can be decomposed to glucose and fructose by sucrase, as the fuel. For more details, sucrose is at least one type of α-glucosidase (EC 3.2.1.20), sucrose-α-glucosidase (EC 3.2.1.48), β-fructofuranosidase (EC 3.2.1.26), and the like.

The fuel cell, in which β-galactosidase is used as the decomposition enzyme and glucose dehydrogenase is used as the oxidizing enzyme, can use lactose, which can be decomposed to glucose and galactose by β-galactosidase, as the fuel.

If necessary, these polysaccharides serving as the fuel may also be immobilized on the negative electrode.

In particular, regarding the fuel cell by using starch as the fuel, a gelatious solidified fuel produced by gelatinizing starch can also be used. In this case, a method in which gelatinized starch is allowed to contact a negative electrode on which the enzyme and the like have been immobilized or is immobilized on the negative electrode together with the enzyme and the like can be employed. If such an electrode is used, the starch concentration on the negative electrode surface can be kept at a level higher than that in the case where starch dissolved in a solution is used, and the decomposition reaction by the enzyme is accelerated, so that the output is improved. In addition, the handling of the fuel is easier than that in the case of the solution and, therefore, a fuel supply system can be simplified. Moreover, inhibition of turnover of the fuel cell is not necessary and, therefore, it is very advantageous to use the fuel cell in mobile apparatuses.

In one example, 2-methyl-1,4-naphthoquinone (VK3) serving as the electron mediator, nicotinamide adenine dinucleotide reduced (NADH) serving as the coenzyme, glucose dehydrogenase serving as the oxidizing enzyme, and diaphorase serving as the coenzyme-oxidizing enzyme are immobilized on a negative electrode. Preferably, they are immobilized at a ratio of 1.0 (mol):0.33 to 1.0 (mol):(1.8 to 3.6)×10⁶ (U):(0.85 to 1.7)×10⁷ (U). Here, U (unit) is an index indicating the enzyme activity and represents a degree of reaction per minute of 1 μmol of substrate at specific temperature and pH.

On the other hand, in the case where the enzyme is immobilized on the positive electrode, typically, this enzyme includes an oxygen-reducing enzyme. As for this oxygen-reducing enzyme, for example, bilirubin oxidase, laccase, and ascorbate oxidase can be used. In this case, preferably, the electron mediator besides the enzyme is also immobilized on the positive electrode. For the electron mediator, for example, potassium hexacyanoferrate and potassium octacyanotungstate are used. Preferably, the electron mediator is immobilized at an adequately high concentration, for example, at an average value of 0.64×10⁻⁶ mol/mm or more.

On the other hand, it has found a phenomenon that the output of the fuel cell was able to be significantly improved by immobilizing a phospholipid, e.g., dimyristoylphosphatidylcholine (DMPC), on the negative electrode in addition to the enzyme and the electron mediator. That is, it was found that the phospholipid functioned as an agent for increasing the output. A variety of studies were conducted on the reason the output was able to be increased by immobilization of the phospholipid, as described above, and the following results were obtained. One of the reasons a satisfactorily large output is not obtained from a fuel cell based on the related art is that the enzyme and the electron mediator immobilized on the negative electrode are not homogeneously mixed and the two are in the state of being aggregated separately from each other. However, the enzyme and the electron mediator can be prevented from being aggregated separately from each other by immobilizing the phospholipid and, therefore, the enzyme and the electron mediator can be homogeneously mixed. Furthermore, the reason the enzyme and the electron mediator was able to be homogeneously mixed by the addition of the phospholipid was researched, and a very rare phenomenon was found in which the diffusion coefficient of the reduced form of the electron mediator was increased significantly by the addition of the phospholipid. That is, it was found that the phospholipid functioned as an electron mediator diffusion accelerator. This effect of immobilization of the phospholipid is significant in the case where the electron mediator is a compound having a quinine skeleton. A similar effect can also be exerted in the case where phospholipid derivatives or polymers of phospholipid or derivatives thereof are used in place of the phospholipid. Most generally, the agent for increasing the output refers to an agent capable of increasing the reaction rate at the electrode on which the enzyme and the electron mediator have been immobilized and increasing the output. Most generally, the electron mediator diffusion accelerator refers to an agent for increasing the diffusion coefficient of the electron mediator in the inside of the electrode on which the enzyme and the electron mediator have been immobilized or maintaining or increasing the concentration of the electron mediator in the vicinity of the electrode.

Regarding the fuel cell according to an embodiment, an oxygen-reducing enzyme is immobilized on a positive electrode with a water-soluble photo-curable resin, a coenzyme-oxidizing enzyme which returns a coenzyme reduced along with oxidation of monosaccharides to an oxidized form and which passes electrons to the negative electrode through the electron mediator is immobilized on the negative electrode with the water-soluble photo-curable resin, and an oxidizing enzyme which facilitates oxidation of the monosaccharides so as to decompose is immobilized thereon with the water-soluble photo-curable resin, while the oxidizing enzyme immobilized with the water-soluble photo-curable resin is formed into the shape of a plurality of islands.

As for the electrode material for the positive or negative electrode, various materials can be used. For example, carbon based materials, e.g., porous carbon, carbon pellets, carbon felt, and carbon paper, are used.

As for the proton conductor, various substances can be used and selected as necessary. Specific examples thereof include substances formed from cellophane, perfluorocarbon sulfonate (PFS) based resin films, copolymer films of trifluorostyrene derivatives, phosphoric acid-impregnated polybenzimidazole films, aromatic polyether ketone sulfonic acid films, PSSA-PVA (polystyrenesulfonic acid polyvinyl alcohol copolymer), PSSA-EVOH (polystyrenesulfonic acid ethylene vinyl alcohol copolymer), and ion exchange resins having a fluorine-containing carbon sulfonic group (Nafion (trade name, DuPont, USA) and the like).

In the case where an electrolyte containing a buffer substance (buffer solution) is used as the proton conductor, in order that a satisfactory buffer capacity can be obtained during a high output operation and the capacity intrinsic to the enzyme can be satisfactorily exerted, it is effective to specify the concentration of the buffer substance contained in the electrolyte to be 0.2 M or more, and 2.5 M or less, preferably 0.2 M or more, and 2 M or less, more preferably 0.4 M or more, and 2 M or less, and further preferably 0.8 M or more, and 1.2 M or less. In general, any buffer substance may be used insofar as pKₐ of 5 or more, and 9 or less is exhibited. Specific examples thereof include dihydrogenphosphate ion (H₂PO₄), 2-amino-2-hydroxymethyl-1,3-propanediol (abbreviated as Tris), 2-(N-morpholino)ethanesulfonic acid (MES), cacodylic acid, carbonic acid (H₂CO₃), hydrogen citrate ion, N-(2-acetamide)iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviated as tricine), glycylglycine, and N,N-bis(2-hydroxyethyl)glycine (abbreviated as bicine). A substance which generates dihydrogenphosphate ion (H₂PO₄⁻) is, for example, sodium dihydrogenphosphate (NaH₂PO₄) and potassium dihydrogenphosphate (KH₂PO₄). As for the buffer substance, compounds having an imidazole ring is also preferable. Specific examples of the compounds having an imidazole ring include imidazole, triazole, pyridine derivatives, bipyridine derivatives, and imidazole derivatives (histidine, 1-methylimidazole, 2-methylimidazole, 4-methylimidazole, 2-ethylimidazole, ethyl imidazole-2-carboxylate, imidazole-2-carboxaldehyde, imidazole-4-carboxylic acid, imidazole-4,5-dicarboxylic acid, imidazol-1-yl-acetic acid, 2-acetylbenzimidazole, 1-acetylimidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, and 1-butylimidazole). Preferably, pH of the electrolyte containing the buffer substance is about 7, but may be any value of 1 to 14 in general.

This fuel cell can be used for almost every things which is in need of an electric power regardless of size. For example, the fuel cell can be used for electronic apparatuses, mobile units (automobiles, two-wheelers, aircrafts, rockets, spacecrafts, and the like), power units, construction machines, machine tools, power generation systems, and cogeneration systems, and the output, the size, the shape, the type of fuel, and the like are determined depending on uses and the like.

Basically, the electronic apparatus may be of any type, and both of portable type and stationary type are included. Specific examples thereof include cellular phones, mobile apparatuses (personal digital assistant (PDA) and the like), robots, personal computers (including both the desktop type and the notebook type), game machines, camcorders (video tape recorder), car-mounted apparatuses, household electric appliances, and industrial products.

In an embodiment having the above-described configuration, immobilization of the enzyme with the photo-curable resin and/or the thermosetting resin can be conducted easily by, for example, mixing the enzyme to be immobilized and a solution containing the photo-curable resin and/or the thermosetting resin at an appropriate ratio, developing the resulting solution on the positive electrode or the negative electrode and, thereafter, applying light for a predetermined time so as to cure the water-soluble photo-curable resin or conducting heating for a predetermined time so as to cure the resin. In this case, at least one type of enzyme can be stably immobilized at an appropriate position on the positive electrode or the negative electrode while the high activity is maintained. Furthermore, the enzyme can be three-dimensionally immobilized by laminating a plurality of enzyme immobilization layers into a desired shape by using the optical molding technology.

Alternatively, after the enzyme is immobilized on the positive electrode and/or the negative electrode with any immobilizing material, a photo-curable resin and/or a thermosetting resin may be laminated thereon. The laminated photo-curable resin and/or thermosetting resin serves as a sealing layer and, thereby, elution of the enzyme and the like immobilized on the positive electrode and/or the negative electrode can be reduced.

According to an embodiment, at least one type of enzyme can be immobilized easily on an optimum position of a positive electrode and/or a negative electrode with reduced damage, and a high performance fuel cell having excellent output characteristic, life, efficiency, and the like can be produced. Consequently, a high performance electronic apparatus and the like can be realized by using the above-described high performance fuel cell.

Furthermore, according to an embodiment, elution of the enzyme and the like immobilized on the positive electrode and/or the negative electrode can be reduced. Therefore, a high performance fuel cell having excellent output characteristic, life, efficiency, and the like can be produced. Consequently, a high performance electronic apparatus and the like can be realized by using the above-described high performance fuel cell.

Additional features and advantages are described herein, and will be apparent from the following Detailed Description and the figures.

### BRIEF DESCRIPTION OF THE FIGURES

FIG. 1 is a schematic diagram showing a biofuel cell according to a first embodiment;

FIG. 2 is a schematic diagram showing the detailed configuration of a negative electrode of the biofuel cell according to the first embodiment, an example of enzyme group immobilized on the negative electrode, and electron passing reactions by the enzyme group;

FIGS. 3A and 3B are schematic diagrams showing a specific configuration example of the biofuel cell according to the first embodiment;

FIG. 4 is a schematic diagram showing the chemical structure of AWP;

FIG. 5 is a sectional view showing the samples in Example 1;

FIG. 6 is a photograph substituted for drawing, showing an optical micrograph of Example 1; and

FIGS. 7A to 7D are sectional views showing the samples in Example 2.

### DETAILED DESCRIPTION

Embodiments will be described below with reference to the drawings. In all drawings of the embodiments, the same or corresponding elements are indicated by the same reference numeral.

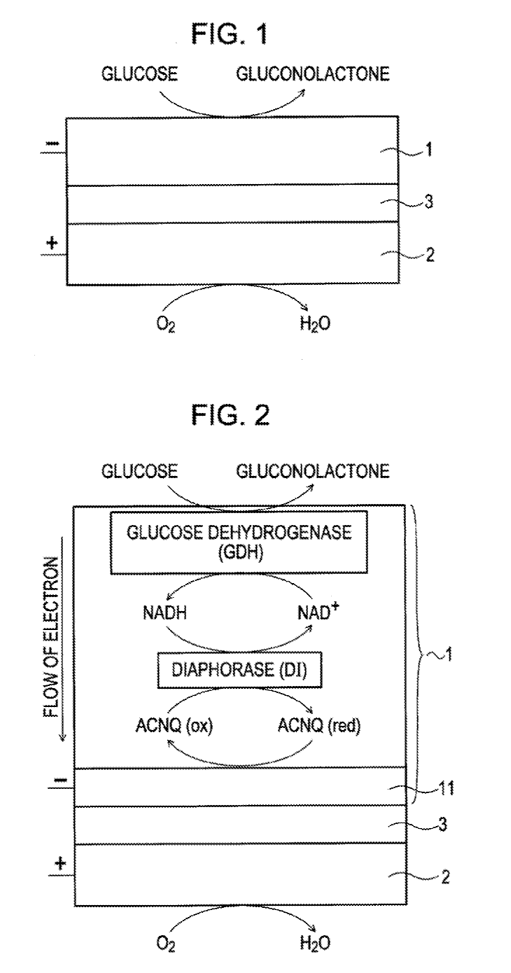

FIG. 1 schematically shows a biofuel cell according to a first embodiment. In this biofuel cell, glucose is used as a fuel. FIG. 2 schematically shows the detailed configuration of a negative electrode of this biofuel cell, an example of enzyme group immobilized on the negative electrode, and electron passing reactions by the enzyme group.

As shown in FIG. 1, this biofuel cell has a structure in which a negative electrode 1 and a positive electrode 2 are opposed with a proton conductor 3 therebetween. The negative electrode 1 decomposes glucose supplied as a fuel with an enzyme so as to take out electrons and generate protons (H⁺). The positive electrode 2 generates water from protons transported from the negative electrode 1 through a proton conductor 3, electrons transferred from the negative electrode 1 through an external circuit, and, for example, oxygen in the air.

The negative electrode 1 has a configuration in which the enzyme involved in decomposition of glucose, a coenzyme (for example, NAD⁺), a reduced form of which is generated along with an oxidation reaction in a decomposition process of glucose, a coenzyme-oxidizing enzyme (for example, diaphorase) which oxidize the reduced form of the coenzyme (for example, NADH), and an electron mediator (for example, ACNQ) which receives electrons generated along with oxidation of the coenzyme from the coenzyme-oxidizing enzyme and pass to the electrode 11 are immobilized on an electrode 11 (refer to FIG. 2) formed from, for example, porous carbon with a water-soluble photo-curable resin. The negative electrode 1 on which the above-described enzyme, coenzyme, and electron mediator are immobilized can be formed easily by, for example, mixing the enzyme, the coenzyme, and the electron mediator with a solution containing the photo-curable resin at an appropriate ratio, developing the resulting solution on the electrode 11 by spin coating, bar coating, contact printing, dipping, or the like and, thereafter, applying light for a predetermined time so as to cure the water-soluble photo-curable resin. As for the water-soluble photo-curable resin, for example, the resins described above can be used. In this case, the immobilization structure of these enzyme, coenzyme, and electron mediator can be formed as a three-dimensional structure having hierarchy. Consequently, these enzyme, coenzyme, and electron mediator can be disposed at any position on the electrode 11. For example, the coenzyme-oxidizing enzyme for oxidizing the reduced form of the coenzyme is immobilized on the electrode 11, and the enzyme involved in decomposition of glucose is immobilized thereon. At this time, for example, an enzyme immobilization layer containing the coenzyme-oxidizing enzyme of the first layer is formed all over the electrode 11, and an enzyme immobilization layer containing the enzyme involved in decomposition of glucose of the second layer is formed into the shape of a plurality of discrete islands, for example, in a two-dimensional array. In the case where the enzyme immobilization layer containing the enzyme involved in decomposition of glucose of the second layer is formed into the shape of a plurality of islands, the contact area with the glucose solution used as the fuel increases, and the efficiency of enzyme reaction can be improved. The coenzyme and the electron mediator are immobilized on, for example, the enzyme immobilization layer of the first layer. The enzyme immobilization layer in the shape of the plurality of islands can be formed easily by applying the light for curing the water-soluble photo-curable resin selectively through the use of a photomask. If necessary, the water-soluble photo-curable resin may be further laminated on an immobilization layer in which the enzyme, the coenzyme, and the electron mediator are immobilized with the water-soluble photo-curable resin so as to serve as a sealing layer.

As for the enzyme involved in decomposition of glucose, for example, glucose dehydrogenase (GDH), and preferably NAD-dependent glucose dehydrogenase can be used. The presence of this oxidizing enzyme can effect oxidation of, for example, β-D-glucose to D-glucono-δ-lactone.

Furthermore, D-glucono-δ-lactone can be decomposed into 2-keto-6-phospho-D-gluconate in the presence of two enzymes, gluconokinase and phosphogluconate dehydrogenase (PhGDH). That is, D-glucono-δ-lactone is converted to D-gluconate by hydrolysis. D-gluconate is phosphorized by hydrolysis of adenosine triphosphate (ATP) to adenosine diphosphate (ADP) and phosphoric acid in the presence of gluconokinase so as to be converted to 6-phospho-D-gluconate. The resulting 6-phospho-D-gluconate is oxidized to 2-keto-6-phospho-D-gluconate by the action of oxidizing enzyme PhGDH.

Furthermore, glucose can also be decomposed to CO₂ through the use of glucose metabolism besides the above-described decomposition process. This decomposition process through the use of glucose metabolism is roughly classified into decomposition of glucose and generation of pyruvic acid through a glycolytic pathway and a TCA cycle. These are well-known reaction systems.

The oxidation reaction in the decomposition process of monosaccharides is conducted with a reduction reaction of the coenzyme. This coenzyme is almost determined depending on the enzyme employed. In the case of GDH, NAD⁺ is used as the coenzyme. That is, when β-D-glucose is oxidized to D-glucono-δ-lactone by the action of GDH, NAD⁺ is reduced to NADH and, thereby, H⁺ is generated.

The generated NADH is immediately oxidized to NAD⁺ in the presence of diaphorase (DI), and two electrons and H⁺ are generated. Therefore, two electrons and two H⁺ per molecule of glucose are generated in one stage of oxidation reaction. Four electrons and four H⁺ in total are generated in two stages of oxidation reaction.

The electrons generated in the above-described process are passed from diaphorase through the electron mediator to the electrode 11, and H⁺ is transported through the proton conductor 3 to the positive electrode 2.

In order that the electrode reaction is efficiently steadily conducted, it is preferable that an electrolyte layer containing a buffer solution, e.g., a phosphate buffer solution and a Tris buffer solution, is used as the proton conductor 3 and the pH of the above-described enzyme, coenzyme, and electron mediator is maintained at, for example, about 7 which is an optimum pH for the enzyme by action of the buffer solution. As for the phosphate buffer solution, for example, NaH₂PO₄ and KH₂PO₄ are used. Furthermore, a too large or too small ionic strength (I.S.) adversely affects the enzyme activity. In consideration of the electrochemical responsibility, an appropriate ionic strength is preferable. However, regarding the pH and the ionic strength, optimum values are different depending on the enzymes employed, and are not limited to the above-described values.

As an example, FIG. 2 shows the case where the enzyme involved in decomposition of glucose is glucose dehydrogenase (GDH), the coenzyme, the reduced form of which is generated along with the oxidation reaction in the decomposition process of glucose, is NAD⁺, the coenzyme-oxidizing enzyme for oxidizing NADH, which is the reduced form of the coenzyme, is diaphorase (DI), and the electron mediator for receiving electrons generated along with oxidation of the coenzyme from the coenzyme-oxidizing enzyme and passing electrons to the electrode 11 is ACNQ.

The positive electrode 2 is prepared by immobilizing the oxygen-reducing enzyme, e.g., bilirubin oxidase, laccase, or ascorbate oxidase, which decomposes oxygen, on a porous carbon electrode or the like with a water-soluble photo-curable resin. The outside portion (the portion opposite to the proton conductor 3) of the positive electrode 2 is usually formed from a gas diffusion layer composed of porous carbon. Preferably, the electron mediator besides the above-described oxygen-reducing enzyme is also immobilized on the positive electrode 2 in order that electrons are passed between the positive electrode 2 and the electron mediator. The positive electrode 2 on which the above-described oxygen-reducing enzyme and electron mediator are immobilized can be formed easily by, for example, mixing the oxygen-reducing enzyme and the electron mediator with a solution containing the photo-curable resin at an appropriate ratio, developing the resulting solution on the electrode and, thereafter, applying light for a predetermined time so as to cure the water-soluble photo-curable resin. As for the water-soluble photo-curable resin, for example, the resins described above can be used. At this time, for example, an enzyme immobilization layer containing the oxygen-reducing enzyme is formed into the shape of a plurality of discrete islands, for example, in a two-dimensional array on the electrode. In the case where the enzyme immobilization layer containing the oxygen-reducing enzyme of the first layer is formed into the shape of a plurality of islands, the contact area with the oxygen supplied from the outside increases, and the efficiency of enzyme reaction can be improved. If necessary, the water-soluble photo-curable resin may be further laminated on an immobilization layer in which the oxygen-reducing enzyme and the electron mediator are immobilized with the water-soluble photo-curable resin so as to serve as a sealing layer.

Regarding the positive electrode 2, water is generated through reduction of oxygen in the air by H⁺ from the proton conductor 3 and electrons from the negative electrode 1 in the presence of the above-described oxygen-reducing enzyme.

The proton conductor 3 transports H⁺ generated at the negative electrode 1 to the positive electrode 2. The proton conductor 3 has no electron conductivity and is formed from a material capable of transporting H⁺. As for the proton conductor 3, for example, the material described above can be used.

In the thus formed biofuel cell, when glucose is supplied to the negative electrode 1 side, glucose is decomposed by the decomposing enzyme containing the oxidizing enzyme. Since the oxidizing enzyme is involved in the decomposition process of the monosaccharides, electrons and H⁺ can be generated on the negative electrode 1 side, and a current can be generated between the negative electrode 1 and the positive electrode 2.

A specific structural example of the biofuel cell will be described below.

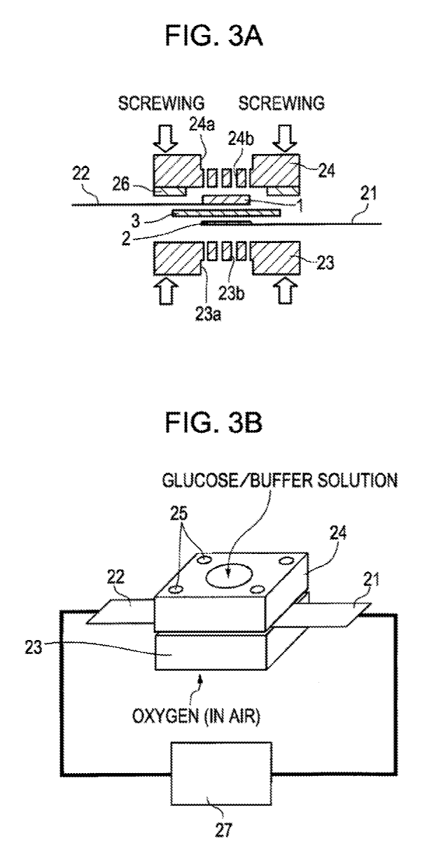

As shown in FIG. 3A and FIG. 3B, this biofuel cell has a configuration in which the negative electrode 1 and the positive electrode 2 are opposed with the proton conductor 3 therebetween. In this case, Ti current collectors 21 and 22 are disposed under the positive electrode 2 and on the negative electrode 1, respectively, in order that current collection can be conducted easily. Reference numerals 23 and 24 denote clamping plates. These clamping plates 23 and 24 are fastened together with screws 25, and the whole of the positive electrode 2, the negative electrode 1, the proton conductor 3 (cellophane or the like), and the Ti current collectors 21 and 22 are sandwiched between them. A circular concave portion 23a for air intake is disposed on one surface (outside surface) of the clamping plate 23. Many holes 23b penetrated to the other surface are disposed in the bottom of the concave portion 23a. These holes 23b serve as air feed channels to the positive electrode 2. On the other hand, a circular concave portion 24a for fuel charge is disposed on one surface (outside surface) of the clamping plate 24. Many holes 24b penetrated to the other surface are disposed in the bottom of the concave portion 24a. These holes 24b serve as fuel feed channels to the negative electrode 1. Spacers 26 are disposed on the peripheral portion of the other surface of the clamping plate 24 in such a way that when the clamping plates 23 and 24 are fastened together with screws, the distance therebetween becomes a predetermined distance.

As shown in FIG. 3B, a load 27 is connected between the Ti current collectors 21 and 22, a fuel, for example, a glucose solution in which glucose is dissolved in a phosphate buffer solution, is put into the concave portion 24a of the clamping plate 24, and power generation is conducted.

In order to prevent liquid leakage of the biofuel cell to the outside, the whole of the positive electrode 2, the negative electrode 1, the proton conductor 3, and the Ti current collectors 21 and 22 may be sealed with a laminate film. The material of the laminate film is PET, polyester, ABS resin, polycarbonate, and the like. Holes for air intake are disposed at positions, for example, corresponding to the holes 23b in the portion on the positive electrode 2 side of the laminate film, and holes for fuel intake are disposed at positions, for example, corresponding to the holes 24b in the portion on the negative electrode 1 side. By employing such a structure, the process for manufacturing the biofuel cell can be simplified. That is, for example, porous electrodes (porous carbon or the like) with no substance immobilized are used as the negative electrode 1 and the positive electrode 2. The whole of the positive electrode 2, the negative electrode 1, the proton conductor 3, and Ti current collectors 21 and 22 are sealed with a transparent laminate film. As described above, this laminate film is provided with holes for air intake in the portion on the positive electrode 2 side and holes for fuel intake in the portion on the negative electrode 1 side. A solution containing the photo-curable resin (water-soluble photo-curable resin or the like) and, if necessary, the electrolyte, besides the oxygen-reducing enzyme and the electron mediator is added to the porous electrode of the positive electrode 2 through the holes for air intake of the laminate film, and is allowed to penetrate into the whole. A solution containing the photo-curable resin (water-soluble photo-curable resin or the like) and, if necessary, the electrolyte, besides the enzyme, the coenzyme, and the electron mediator is added to the porous electrode of the negative electrode 1 through the holes for fuel intake of the laminate film, and is allowed to penetrate into the whole. Subsequently, light is applied to the porous electrode of the positive electrode 2 through the laminate film so as to cure the photo-curable resin and, thereby, immobilize the oxygen-reducing enzyme, the electron mediator, and if necessary, the electrolyte. Furthermore, light is applied to the porous electrode of the negative electrode 1 through the laminate film so as to cure the photo-curable resin and, thereby, immobilize the enzyme, the coenzyme, the electron mediator, and if necessary, the electrolyte. A thermosetting resin may be used instead of the above-described photo-curable resin, and curing may be conducted by using heat instead of the light. The above-described methods can be applied to not only the biofuel cell, but also general cases in which enzymes and the like are immobilized on an electrode with a photo-curable resin.

### EXAMPLE 1

Two types of enzymes, specifically glucose dehydrogenase (GDH) and diaphorase (DI), were immobilized on an electrode 11 of a negative electrode 1 with hierarchy, while desired amounts were disposed at desired places. The enzyme had a very small size on the order of nanometers and is difficult to detect as it is. Therefore, the two types of enzymes were labeled with different fluorochromes through covalent binding.

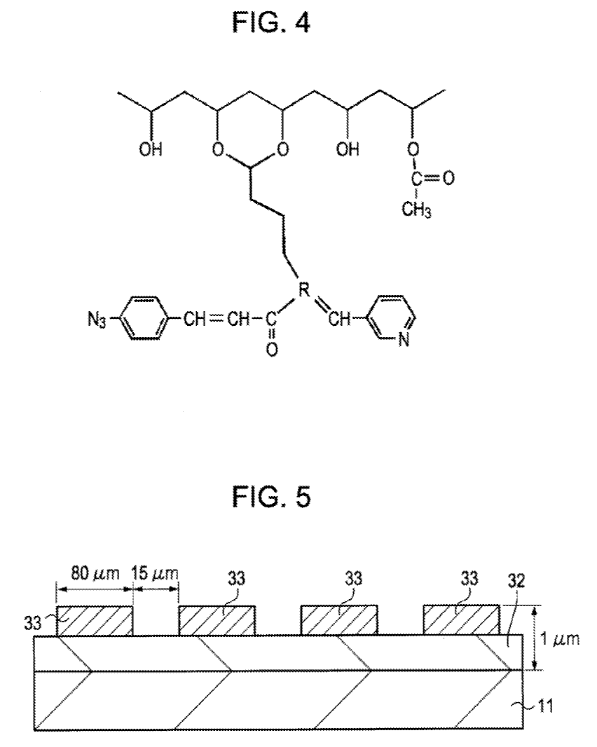

As for the water-soluble photo-curable resin used for immobilizing the enzyme, AWP (Azide-unit Pendant Water-soluble Photopolymer) (produced by Toyo Gosei Co., Ltd.) was used. AWP is a water-soluble photo-curable resin which is azide based photosensitive group pendant polyvinyl alcohol and has a structure shown in FIG. 4.

AWP was mixed with a solution containing DI with fluorescence label at an appropriate ratio. The resulting solution was dropped on the electrode 11, development was conducted with a spin coater, so that a flat film having a desired thickness was prepared. Ultraviolet rays were applied to the resulting flat film with an ultraviolet (UV) irradiation apparatus so as to cure AWP. In this manner, as shown in FIG. 5, an enzyme immobilization layer 32 serving as a first layer in which DI was immobilized with AWP was formed all over the electrode 11. Subsequently, AWP was mixed with a solution containing GDH with fluorescence label at an appropriate ratio. The resulting solution was dropped on the enzyme immobilization layer 32, development was conducted with a spin coater, so that a flat film having a desired thickness was produced. Thereafter, ultraviolet rays were selectively applied to the resulting flat film with the UV irradiation apparatus by using a photomask provided with square openings which had the size of 80 μm×80 μm and which were disposed in a two-dimensional array at a distance of 15 μm, so as to cure AWP. The flat film exposed to the light was developed with water so as to remove an unexposed portion. In this manner, as shown in FIG. 5, an enzyme immobilization layer 33 serving as a second layer in which GDH was immobilized with AWP was formed into the shape of square islands which had the size of 80 μm×80 μm and which were disposed in a two-dimensional array at a distance of 15 μm. The total thickness of the enzyme immobilization layers 32 and 33 was about 1 μm.

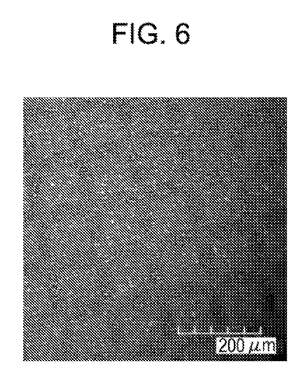

The optical micrograph of the enzyme immobilization layers 32 and 33 formed on the electrode 11, as described above, is shown in FIG. 6.

It was verified by Example 1 that GDH and DI were able to be three-dimensionally immobilized on the electrode 11 with hierarchy.

### EXAMPLE 2

As described above, typically, two types of enzymes, specifically GDH and DI, the coenzyme, and the electron mediator are immobilized on the electrode 11 of the negative electrode 1. In Example 2, an experiment was conducted, in which a glassy carbon electrode was used as the electrode 11, and these GDH, DI, coenzyme, and electron mediator were immobilized thereon. The results thereof will be described.

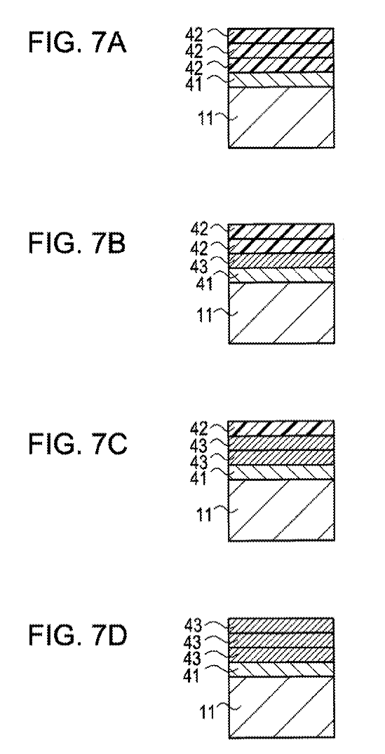

As shown in FIGS. 7A 7B, 7C, and 7D, four samples (Samples 1 to 4) were prepared. Regarding Sample 1 shown in FIG. 7A, an enzyme and coenzyme immobilization layer 41 in which GDH and DI serving as the enzymes and NADH serving as the coenzyme were immobilized with AWP was formed on the electrode 11, and three water-soluble photo-curable resin layers 42 were formed thereon. Regarding Sample 2 shown in FIG. 7B, an enzyme and coenzyme immobilization layer 41 was formed on the electrode 11, an electron mediator immobilization layer 43 in which ANQ serving as the electron mediator was immobilized with AWP was formed thereon, and two water-soluble photo-curable resin layers 42 were formed thereon. Regarding Sample 3 shown in FIG. 7C, an enzyme and coenzyme immobilization layer 41 was formed on the electrode 11, two electron mediator immobilization layers 43 in which ANQ serving as the electron mediator was immobilized with AWP was formed thereon, and one water-soluble photo-curable resin layer 42 was formed thereon. Regarding Sample 4 shown in FIG. 7D, an enzyme and coenzyme immobilization layer 41 was formed on the electrode 11 and three electron mediator immobilization layers 43 in which ANQ serving as the electron mediator was immobilized with AWP were formed thereon. The thickness of each layer of these coenzyme immobilization layer 41, water-soluble photo-curable resin layer 42, and electron mediator immobilization layer 43 in Samples 1 to 4 was measured with a contact type thickness tester, resulting in about 3 μm.

Samples 1 to 4 prepared as described above were used and an electrochemical measurement was conducted in a glucose solution. The glucose concentration was specified to be 400 mM. Regarding Sample 1 in which the electron mediator was not immobilized, the current density was about 0 mA/cm² because electron transfer was not able to be conducted. Regarding Sample 2 in which one electron mediator immobilization layer 43 was formed (amount of immobilization of ANQ was 4 μL), the current density was about 0.21 mA/cm². Regarding Sample 3 in which two electron mediator immobilization layers 43 were formed (amount of immobilization of ANQ was 8 μL), the current density was about 0.32 mA/cm². Regarding Sample 4 in which three electron mediator immobilization layers 43 were formed (amount of immobilization of ANQ was 12 μL), the current density was about 0.42 mA/cm². Consequently, it was made clear that the current density was nearly proportionate to the number of the electron mediator immobilization layers 43.

It was verified by Example 2 that GDH and DI serving as the enzymes, ANQ serving as the electron mediator, and NADH serving as the coenzyme were able to be laminated on the electrode 11.

Furthermore, it was verified that in order to obtain a catalyst current, the electron mediator was needed in this combination of enzymes, and the current density was proportionate to the amount of immobilization of electron mediator within a certain range.

### EXAMPLE 3

The enzyme was immobilized on a porous carbon electrode by using the water-soluble photo-curable resin.

In order to cure the water-soluble photo-curable resin together with the enzyme and other constituent components on the electrode, application of ultraviolet rays with appropriate wavelengths is required. For example, regarding the porous carbon electrode having a porosity of about 60%, it is known that light passes through about 0.3 mm of thickness. Therefore, a porous carbon electrode having a thickness of 0.5 mm was used, and ultraviolet rays were applied from both sides. Consequently, the ultraviolet rays were able to be applied throughout the inside of the porous carbon electrode, and an immobilization layer was able to be formed on the porous carbon electrode with a solution of an enzyme and the like including a water-soluble photo-curable resin solution.

Specifically, a porous carbon electrode having a thickness of 0.5 mm was used, and 30 μL of solution in which 8 μL of enzyme (GDH, DI) stock solution, 2 μL of NADH solution, 12 μL of phosphate buffer solution serving as a buffer solution, 18.7 μL of ANQ solution, and 20 μL of AWP solution were mixed was added to each of both surfaces, drying was conducted appropriately, and ultraviolet rays were applied for an appropriate time. In this manner, a porous carbon electrode was prepared, on which GDH, DI, NADH, and ANQ were immobilized with AWP. Four porous carbon electrodes, on which the enzymes and the like were immobilized, as described above, and which had a thickness of 0.5 mm, were stacked in such a way that the thickness became 2 mm and, thereafter, an electrochemical measurement was conducted with a single-pole cell.

For purposes of comparison, a porous carbon electrode was prepared, on which GDH, DI, NADH, and ANQ were immobilized by a polyion complex method based on the related art. Specifically, 75 μL of solution in which 32 μL of enzyme (GDH, DI) stock solution, 8 μL of NADH solution, 40 μL of phosphate buffer solution serving as a buffer solution, and 74.8 μL of ANQ solution were mixed was dropped on each of both surfaces of a porous carbon electrode having a thickness of 2 mm, and drying was conducted appropriately. Furthermore, 20 μL of poly-L-lysine (PLL) solution was dropped on each of both surfaces of the porous carbon electrode, and drying was conducted appropriately. Moreover, 24 μL of polyacrylic acid solution was added to each of both surfaces of the porous carbon electrode, and drying was conducted appropriately. In this manner, the porous carbon electrode for comparison was prepared.

The composition of the electrolyte solution was an imidazole buffer solution (pH 7.0), and an electrochemical evaluation was conducted at a glucose concentration of 600 mM. As a result of comparison between the porous carbon electrode prepared by using the photo-curable resin (Example 3) and the porous carbon electrode for comparison (Comparative example), the catalyst current value was able to be obtained in both cases. Furthermore, the current values at an elapsed time of 10 minutes and at an elapsed time of 1 hour were compared. Regarding Comparative example in which the polyion complex method was used for immobilization, the values were 8.56 mA/cm² and 3.19 mA/cm², respectively. On the other hand, regarding Example 3 in which the water-soluble photo-curable resin was used for immobilization, the values were 11.9 mA/cm² and 4.27 mA/cm², respectively. Therefore, it was made clear that the catalyst current value was able to be obtained in the case where the porous carbon electrode was used as well by using the water-soluble photo-curable resin for immobilization. Furthermore, it was made clear that the catalyst current value still larger than the value in the case where the polyion complex method based on the related art was used for immobilization was able to be obtained.

It was verified by Example 3 that the enzyme immobilization layer was able to be prepared by using the water-soluble photo-curable resin on not only the flat electrode, e.g., the glassy carbon electrode, but also the porous carbon electrode having a three-dimensionally complicated structure, and the catalyst current value still larger than the value of the porous carbon electrode prepared by using the polyion complex method based on the related art was able to be obtained.

As described above, according to the first embodiment, two types of enzymes, the coenzyme, and the electron mediator are immobilized on the negative electrode 1 with the water-soluble photo-curable resin, and likewise, the enzyme and the electron mediator are immobilized on the positive electrode 2 with the water-soluble photo-curable resin. Therefore, enzymes can be immobilized at desired positions while the activity is maintained without damaging these enzymes. A desired amount of enzyme can be three-dimensionally immobilized at a desired position in a desired arrangement by using the optical molding technology. In particular, fine enzyme immobilization structure on the scale of nanometers or micrometers can be two-dimensionally or three-dimensionally formed at will by using a photomask which is used for light irradiation to cure a water-soluble photo-curable resin in the semiconductor process and the like. Therefore, a high performance biofuel cell having excellent output characteristic, life, efficiency, and the like can be produced. In addition, immobilization of a substances e.g., an enzyme, is conducted merely by mixing the substance with a solution containing a water-soluble photo-curable resin, applying the resulting solution, and curing the water-soluble photo-curable resin through light irradiation. Consequently, the immobilization can be conducted easily, and by extension a production cost of the biofuel cell can be reduced.

A biofuel cell according to a second embodiment will be described below.

In this biofuel cell, an enzyme, a coenzyme, and an electron mediator are immobilized on a negative electrode 1 by any method including the polyion complex method and the like based on the related art, and likewise, an oxygen-reducing enzyme and an electron mediator are immobilized on a positive electrode 2 by any method including the polyion complex method and the like based on the related art. Thereafter, a photo-curable resin and/or a thermosetting resin is laminated on the resulting immobilization layer in a manner similar to that in the first embodiment, and this is used as a sealing layer.

This biofuel cell is the same as that in the first embodiment except those described above.

### EXAMPLE 4

As in Examples 1 to 3, by using a solution containing a water-soluble photo-curable resin, an immobilization layer containing an enzyme and the like can be formed on not only the flat electrode, e.g., the glassy carbon electrode, but also an electrode, e.g., a porous carbon electrode, having a complicated structure. Furthermore, it has been verified that lamination thereof can be conducted as well. In Example 4, an experiment was conducted, in which a step of laminating a water-soluble photo-curable resin on an immobilization layer prepared by any method was applied and effects thereof were examined. The results thereof will be described.

Here, the immobilization layer was prepared by using the polyion complex method based on the related art. Specifically, a solution in which 8 μL of enzyme (GDH, DI) stock solution, 2 μL of NADH solution, 10 μL of phosphate buffer solution serving as a buffer solution, and 18.7 μL of ANQ solution were mixed was dropped on a glassy carbon electrode, and drying was conducted appropriately. Furthermore, 10 μL of poly-L-lysine (PLL) solution was dropped on each of both surfaces, and drying was conducted appropriately. Moreover, 12 μL of polyacrylic acid solution was dropped on each of both surfaces, and drying was conducted appropriately. In this manner, the glassy carbon electrode for comparison was prepared (Sample 11).

Sample 12 was prepared by further laminating a water-soluble photo-curable resin on the electrode for comparison.

Moreover, Sample 13 was prepared, wherein an electrode was prepared by a method in which an enzyme was immobilized with a photo-curable resin. Specifically, a solution in which 8 μL of enzyme (GDH, DI) stock solution, 2 μL of NADH solution, 18.7 μL of ANQ solution, and 10 μL of AWP solution were mixed was added to a glassy carbon electrode, drying was conducted appropriately, and ultraviolet rays were applied for an appropriate time. In this manner, a glassy carbon electrode was prepared, on which GDH, DI, NADH, and ANQ were immobilized with AWP, so that Sample 13 was provided.

The composition of the electrolyte solution was an imidazole buffer solution (pH 7.0), and an electrochemical evaluation was conducted at a glucose concentration of 400 mM. As a result of potentiostatic measurement at 0.1 V and an elapsed time of 1 hour, the value of the glassy carbon electrode (Sample 11) prepared by using the polyion complex method was 0.26 mA/cm², the value of Sample 12 in which the water-soluble photo-curable resin was further laminated was 1.37 mA/cm², and the value of Sample 13 in which the enzyme was immobilized with the water-soluble photo-curable resin and the water-soluble photo-curable resin was further laminated was 0.89 mA/cm². A significant increase in the catalyst current value due to lamination of the water-soluble photo-curable resin was not influenced by the method of immobilization of the enzyme and the like and, therefore, was estimated to be the effect of the laminated water-soluble photo-curable resin. It is believed that the immobilization film, in which the enzyme and the like are immobilized, is protected by the laminated water-soluble photo-curable resin, a favorable reaction site is provided, and a function as a sealing layer reduces elution of the enzyme and the like, which are constituent components, into the electrolyte solution.

It was verified by Example 4 that the water-soluble photo-curable resin was able to be laminated on the immobilization layer, in which the enzyme and the like are immobilized by any immobilization method, and the catalyst current value at an elapsed time of 1 hour increased significantly.

### EXAMPLE 5

Example 4 shows that the film of water-soluble photo-curable resin laminated on the immobilization layer functions as a sealing layer. In Example 5, the experiment results showing that not only the water-soluble photo-curable resin, but also functional resins having other properties function as the sealing layer will be described.

Specifically, an immobilization layer was prepared on a glassy carbon electrode by using the polyion complex method, as in Example 4, so that Sample 21 was provided.

Furthermore, 10 μL of solution prepared by diluting a water-soluble acrylic synthetic resin paint (produced by Daiso Sangyo) with pure water appropriately was dropped thereon, and drying was conducted, so that Sample 22 was provided.

Sample 21 and Sample 22 were compared on the basis of the potentiostatic measurement at 0.1 V. As a result, the value of Sample 21 was 0.26 mA/cm² at an elapsed time of 1 hour, whereas the value of Sample 22 was 1.06 mA/cm².

It was made clear from Example 5 that the catalyst current value also increased, as in Example 4, in the case where the water-soluble acrylic synthetic resin paint was laminated on the immobilization layer of the enzyme and the like prepared by using the polyion complex method.

### EXAMPLE 6

In Example 5, the immobilization layer was prepared on the flat plate glassy carbon electrode. In Example 6, the results of comparative experiments between an electrode in which an immobilization layer of the enzyme and the like was formed on a porous carbon electrode and an electrode in which an immobilization layer of the enzyme and the like was formed on a porous carbon electrode and, furthermore, a water-soluble acrylic synthetic resin paint was laminated thereon will be described.

Specifically, 75 μL of solution in which 32 μL of enzyme (GDH, DI) stock solution, 8 μL of NADH solution, 40 μL of phosphate buffer solution serving as a buffer solution, and 74.8 μL of ANQ solution were mixed was dropped on each of both surfaces of a porous carbon electrode having a thickness of 2 mm, and drying was conducted appropriately. Furthermore, 20 μL of poly-L-lysine (PLL) solution was dropped on each of both surfaces of the porous carbon electrode, and drying was conducted appropriately. Moreover, 24 μL of polyacrylic acid solution was added to each of both surfaces of the porous carbon electrode, and drying was conducted appropriately. In this manner, the porous carbon electrode for comparison was prepared. This was taken as Sample 31.

Furthermore, a water-soluble acrylic synthetic resin paint was laminated on the porous carbon electrode of Sample 31, so that Sample 32 was provided.

The above-described two porous carbon electrodes were compared on the basis of the potentiostatic measurement at 0.1 V. As a result, the value of Sample 31 was 2.39 mA/cm² at an elapsed time of 1 hour, and the value of Sample 32 was 3.01 mA/cm². As in Example 5, the catalyst current value was able to be increased by a factor of about 1.3 by lamination of the water-soluble acrylic synthetic resin paint. This was estimated to be the same effect as the effect of reduction in elution of constituent components from the immobilization layer due to the water-soluble photo-curable resin, as indicated in Examples 3 and 4.

It was verified by Example 6 that a very good catalyst current value was obtained by laminating the water-soluble acrylic synthetic resin paint on the immobilization layer in which the enzyme and the like were immobilized on the porous carbon electrode by using the polyion complex method.

As described above, according to the second embodiment, the enzymes, the coenzyme, and the electron mediator are immobilized on the negative electrode 1 by any method, the oxygen-reducing enzyme and the electron mediator are immobilized on the positive electrode 2 by any method likewise, and the water-soluble photo-curable resin and/or thermosetting resin is laminated on the immobilization layer. Consequently, this photo-curable resin and/or thermosetting resin serves as a sealing layer, and elution of the constituent components of the immobilization layer can be reduced. In addition, this photo-curable resin and/or thermosetting resin serves as a protective layer of the immobilization film so as to form a good enzyme reaction site and, thereby, a high performance biofuel cell having excellent output characteristic, life, efficiency, and the like can be produced. Furthermore, since the photo-curable resin and/or thermosetting resin laminated on the immobilization layer also serves as a protective layer, the immobilization layer can be prevented from being scratched or damaged through, for example, contact with an external substance.

The above-described embodiments are not limited to the examples described herein.

For example, the numerical values, the structures, the configurations, the shapes, the materials, and the like are no more than examples, and numerical values, structures, configurations, shapes, materials, and the like different therefrom may be employed as necessary.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for manufacturing a fuel cell having a structure in which a positive electrode and a negative electrode are opposed with a proton conductor therebetween and an enzyme is immobilized on the positive electrode and/or the negative electrode, the method comprising:
immobilizing the enzyme on the positive electrode and/or the negative electrode with a photo-curable resin and/or a thermosetting resin.

2. The method for manufacturing a fuel cell according to claim 1,
wherein the photo-curable resin is a water-soluble photo-curable resin, and
the thermosetting resin is a water-soluble thermosetting resin.

3. The method for manufacturing a fuel cell according to claim 1, including
applying a solution containing the enzyme and the photo-curable resin to the positive electrode and/or the negative electrode, and
curing the photo-curable resin through light irradiation.

4. The method for manufacturing a fuel cell according to claim 1, including
immobilizing the enzyme on the positive electrode and/or the negative electrode with the photo-curable resin and/or the thermosetting resin, and
laminating a photo-curable resin and/or a thermosetting resin on the photo-curable resin and/or the thermosetting resin.

5. The method for manufacturing a fuel cell according to claim 1, wherein an electron mediator besides the enzyme is immobilized on the positive electrode and/or the negative electrode.

6. The method for manufacturing a fuel cell according to claim 5, including
immobilizing an oxygen-reducing enzyme on the positive electrode with the photo-curable resin and/or the thermosetting resin,
immobilizing a coenzyme-oxidizing enzyme which returns a coenzyme reduced along with oxidation of monosaccharides to an oxidized form and which passes electrons to the negative electrode through the electron mediator on the negative electrode with the photo-curable resin and/or the thermosetting resin, and
an oxidizing enzyme which facilitates oxidation of the monosaccharides so as to decompose is immobilized thereon with the photo-curable resin and/or the thermosetting resin, while the oxidizing enzyme immobilized with the photo-curable resin and/or the thermosetting resin is formed into the shape of a plurality of islands at that time.

7. The method for manufacturing a fuel cell according to claim 6,
wherein the oxidized form of the coenzyme is NAD⁺, and
the coenzyme-oxidizing enzyme is diaphorase.

8. The method for manufacturing a fuel cell according to claim 6,
wherein the oxidizing enzyme is NAD⁺-dependent glucose dehydrogenase.

9. A fuel cell comprising a structure in which
a positive electrode and a negative electrode are opposed with a proton conductor therebetween and
an enzyme is immobilized on the positive electrode and/or the negative electrode,
wherein the enzyme is immobilized on the positive electrode and/or the negative electrode with a photo-curable resin and/or a thermosetting resin.

10. The fuel cell according to claim 9,
wherein an oxygen-reducing enzyme is immobilized on the positive electrode with the photo-curable resin and/or the thermosetting resin,
a coenzyme-oxidizing enzyme which returns a coenzyme reduced along with oxidation of monosaccharides to an oxidized form and which passes electrons to the negative electrode through an electron mediator is immobilized on the negative electrode with the photo-curable resin and/or the thermosetting resin, and
an oxidizing enzyme which facilitates oxidation of the monosaccharides so as to decompose is immobilized thereon with the photo-curable resin and/or the thermosetting resin, while the oxidizing enzyme immobilized with the photo-curable resin and/or the thermosetting resin is formed into the shape of a plurality of islands.

11. An electronic apparatus including at least one fuel cell, at least one of the fuel cells comprising a structure in which
a positive electrode and a negative electrode are opposed with a proton conductor therebetween and
an enzyme is immobilized on the positive electrode and/or the negative electrode,
wherein the enzyme is immobilized on the positive electrode and/or the negative electrode with a photo-curable resin and/or a thermosetting resin.

12. A method for manufacturing a fuel cell having a structure in which a positive electrode and a negative electrode are opposed with a proton conductor therebetween and an enzyme is immobilized on the positive electrode and/or the negative electrode, the method comprising:
immobilizing the enzyme on the positive electrode and/or the negative electrode with an immobilizing material; and
laminating a photo-curable resin and/or a thermosetting resin on the immobilizing material.

13. The method for manufacturing a fuel cell according to claim 12, wherein the immobilizing material comprises a polyion complex.

14. A fuel cell comprising a structure in which
a positive electrode and a negative electrode are opposed with a proton conductor therebetween and
an enzyme is immobilized on the positive electrode and/or the negative electrode,
wherein the enzyme is immobilized on the positive electrode and/or the negative electrode with an immobilizing material, and
a photo-curable resin and/or a thermosetting resin is laminated on the immobilizing material.

15. An electronic apparatus including at least one fuel cell, at least one of the fuel cells comprising a structure in which
a positive electrode and a negative electrode are opposed with a proton conductor therebetween and
an enzyme is immobilized on the positive electrode and/or the negative electrode,
wherein the enzyme is immobilized on the positive electrode and/or the negative electrode with an immobilizing material, and
a photo-curable resin and/or a thermosetting resin is laminated on the immobilizing material.
